(19) United States
(12) Patent Application Publication
(10) Pub. No.: US 2018/0292553 A1
(43) Pub. Date: Oct. 11, 2018

(54) Method and Apparatus for Separating Seismic Diffracted Wave

(71) Applicant: INSTITUTE OF GEOLOGY AND GEOPHYSICS, CHINESE ACADEMY OF SCIENCES, Beijing (CN)

(72) Inventors: Caixia YU, Beijing (CN); Yanfei WANG, Beijing (CN)

(21) Appl. No.: 15/574,212

(22) PCT Filed: May 18, 2017
(86) PCT No.: PCT/CN2017/084791

§ 371 Date: Nov. 15, 2017

(30) Foreign Application Priority Data
Jan. 10, 2017 (CN) 201710019616.7

(51) Int. Cl. G01V 1/30

(52) U.S. Cl. CPC G01V 1/302

(57) ABSTRACT

Method and apparatus for separating seismic diffracted waves, in seismic exploration field. The method comprises acquiring seismic shot gather data carrying underground geological information in preset geological region; inputting preprocessed single-shot data obtained by preprocessing seismic shot gather data and a preset migration velocity model to three-dimensional single-shot angle domain imaging formula and performing wave field back-propagation processing on the seismic shot gather data to obtain information of azimuth, emergence angle and amplitude of propagation rays, according to which three-dimensional angle domain imaging matrix is generated, the obtained information corresponding one by one to underground imaging points in the preset geological region; separating low-rank matrix component from the three-dimensional angle domain imaging matrix and determining the low-rank matrix component as the seismic diffracted wave through a preset three-dimensional diffracted wave separating model, improving amplitude integrity and waveform consistency of separated diffracted waves and imaging resolution of geological structures.

### CROSS REFERENCE TO RELATED APPLICATIONS

The present application claims the priority of the Chinese Patent Application No. 201710019616.7, entitled “Method and Apparatus for Separating Seismic Diffracted Wave”, filed with the Chinese Patent Office on Jan. 10, 2017, the entity of which is incorporated herein by reference.

### TECHNICAL FIELD

The present invention relates to the technical field of seismic exploration, and particularly to a method and an apparatus for separating a seismic diffracted wave.

### BACKGROUND ART

Carbonate oil-gas reservoir has become a main field for increasing reserves and production of oil-gas resources. However, carbonate stratum structures in some regions are quite special so that the formation and distribution of the carbonate reservoirs are relatively complex, causing it unable to finely image geological bodies, such as karst caves and cracks.

In the prior art, the seismic exploration in the petroleum industry mainly relies on the reflected wave, but the resolution of exploration through the reflected wave is limited, making it unable to effectively identify the geological bodies of the carbonate stratum structures. Meanwhile, since a seismic response of the geological bodies of the carbonate stratum structures is embodied as the diffracted wave, effectively separating the diffracted wave is crucial to exploration of fractured-vuggy carbonate oil-gas reservoir. Most of conventional methods for separating the diffracted wave employ kinematic characteristics of the reflected wave and the diffracted wave to separate the diffracted wave through a signal processing method. However, in the collected three-dimensional shot gather data, the diffracted wave has highly similar kinematic characteristics to the reflected wave, and is hard to be effectively processed merely through a wave-field separating method in the conventional kinematics, resulting in low imaging resolutions of the carbonate stratum structures.

An effective solution has not yet been put forward to the above problem that amplitude integrity and waveform consistency of the diffracted wave separated by the above manner of separating the seismic diffracted wave are relatively poor.

### DISCLOSURE OF THE INVENTION

In view of this, an object of the present invention is to provide a method and an apparatus for separating seismic diffracted wave, so as to improve amplitude integrity and waveform consistency of the separated diffracted wave.

In a first aspect, an example of the present invention provides a method for separating a seismic diffracted wave, comprising: acquiring seismic shot gather data carrying underground geological information in a preset geological region, wherein the underground geological information comprises geological structure information and geological lithology change information; performing wave field back-propagation processing on the seismic shot gather data to obtain azimuth, emergence angle and amplitude information of propagation rays corresponding one by one to underground imaging points in the preset geological region; generating a three-dimensional angle domain imaging matrix according to the azimuth, emergence angle and amplitude information of the propagation rays; and separating a low-rank matrix component from the three-dimensional angle domain imaging matrix and determining the low-rank matrix component as the seismic diffracted wave.

In combination with the first aspect, an example of the present invention provides a first possible implementation of the first aspect, specifically, the above step of performing wave field back-propagation processing on the seismic shot gather data to obtain azimuth, emergence angle and amplitude information of propagation rays corresponding one by one to underground imaging points in the preset geological region comprises: preprocessing the seismic shot gather data to obtain preprocessed single-shot data, wherein the preprocessed single-shot data is seismic shot gather data usable for direct imaging, and the preprocessing comprises de-noising the seismic shot gather data and making the seismic shot gather data corresponding to pre-stored historical seismic data one by one; and inputting the preprocessed single-shot data and a preset migration velocity model to a three-dimensional single-shot angle domain imaging formula, and performing the wave field back-propagation processing on the seismic shot gather data, to obtain the azimuth, emergence angle and amplitude information of the propagation rays corresponding one by one to the underground imaging points in the preset geological region, wherein the three-dimensional single-shot angle domain imaging formula includes a three-dimensional amplitude compensation factor.

In combination with the first possible implementation of the first aspect, an example of the present invention provides a second possible implementation of the first aspect, specifically, the above three-dimensional single-shot angle domain imaging formula comprises:

$$R ( x , {θ}_{0} , {ϕ}_{0} ) = \int \int δ ( θ - {θ}_{0} ) δ ( ϕ - {ϕ}_{0} ) δ ( t - {t}_{0} ) {W}_{3 D} ( s , x , r ) u ( s , r , t ) drdt$$

$$\{ \begin{matrix}cos {θ}_{0} = \frac{k \cdot {k}_{r}}{\vert k \vert \vert {k}_{r} \vert} \\ cos {ϕ}_{0} = \frac{( {k}_{s} \times {k}_{r} ) \cdot ( {n}_{x} \times ( {k}_{s} + {k}_{r} ) )}{\vert {k}_{s} \times {k}_{r} \vert \vert ( {n}_{x} \times ( {k}_{s} + {k}_{r} ) ) \vert}\end{matrix}$$

in which δ represents an impulse function, R(x,θ₀,φ₀) represents a three-dimensional angle domain imaging matrix, wherein a ray excited by a hypocenter s reaches a demodulation point position r through any imaging point x in an underground space; a vector kₛ represents a ray parameter from the hypocenter to the imaging point, a vector kᵣ represents a ray parameter from the demodulation point to the imaging point; a parameter θ represents an emergence angle; a parameter φ represents an azimuth; a vector k represents a normal vector of an assumed reflecting interface; k is calculated through the following formula: k(ωₘ,φₘ)=kₛ(θₛ,φₛ)+kᵣ(θᵣ,φᵣ); θₛ and φₛ represent an emergence angle and an azimuth of kₛ respectively; θᵣ and φᵣ represent an emergence angle and an azimuth of kᵣ respectively; θₘ and φₘ represent an emergence angle and an azimuth of the assumed reflecting interface respectively; nₓ represents a normal vector in an x direction of a three-dimensional coordinate system, and nₓ=(1,0,0); u(s,r,t) represents seismic data, t represents recording time of the seismic data; t₀ represents ray travel time; and W_{3D}(s,x,r) represents a three-dimensional amplitude compensation factor.

In combination with the second possible implementation of the first aspect, an example of the present invention provides a third possible implementation of the first aspect, specifically, the above three-dimensional amplitude compensation factor W_{3D}(s,x,r) comprises:

$${W}_{3 D} ( s , x , r ) = \frac{1}{{v}_{s}} \sqrt{cos {α}_{s} cos {α}_{r}} \frac{\vert det ( {\underline{N}}_{1}^{T} \underline{Σ} + {\underline{N}}_{2}^{T} \underline{Γ} ) \vert}{\sqrt{\vert det {\underline{N}}_{1} \vert \vert det {\underline{N}}_{2} \vert}} {e}^{- i \frac{π}{2} ( {κ}_{1} + {κ}_{2} )}$$

in which νₛ represents a velocity at a hypocenter position, αₛ represents an incident angle of a ray at the hypocenter position, αᵣ represents an emergence angle of a ray at a demodulation point position, N₁ and N₂ represent mixed derivatives of the travel time of a first ray and a second ray with respect to the hypocenter position and the demodulation point position respectively, T represents a matrix transposition operation, wherein the travel time is calculated according to three-dimensional wavefront reconstruction method ray tracing, and multi-valued travel time is taken into consideration in the calculation; the first ray is a ray from the hypocenter to the imaging point; the second ray is a ray from the demodulation point to the imaging point; Σ and Γ represent matrixes related to a manner of seismic observation, and in a situation of common shot observation, Σ=0,Γ=I, wherein I represents a unit matrix; i represents an imaginary unit of a complex number, and κ₁ and κ₂ represent numbers of caustic points of the first ray and the second ray respectively, with κ₁ and κ₂ being calculated by a three-dimensional ray tracing kinetic equation.

In combination with the first aspect, an example of the present invention provides a fourth possible implementation of the first aspect, specifically, the above step of separating a low-rank matrix component from the three-dimensional angle domain imaging matrix and determining the low-rank matrix component as the seismic diffracted wave comprises: separating, through a preset three-dimensional diffracted wave separating model, the low-rank matrix component from the three-dimensional angle domain imaging matrix, and determining the low-rank matrix component as the seismic diffracted wave, wherein the preset three-dimensional diffracted wave separating model comprises:

R(xᵢ,θ,φ)=L(xᵢ,θ,φ)+S(xᵢ,θ,φ)

in which R(xᵢ,θ,φ) represents a three-dimensional angle domain imaging matrix of an i-th imaging point at a position xᵢ; L(xᵢ,θ,φ) represents a low-rank matrix component after decomposition of the three-dimensional angle domain imaging matrix; S(xᵢ,θ,φ) represents a sparse matrix component after decomposition of the three-dimensional angle domain imaging matrix; xᵢ represents the i-th imaging point; a parameter θ represents an emergence angle; and a parameter φ represents an azimuth.

In combination with the fourth possible implementation of the first aspect, an example of the present invention provides a fifth possible implementation of the first aspect, specifically, the above preset three-dimensional diffracted wave separating model further comprises:

$$J ( L , S , Y , β ) = {‖ L ‖}_{*} + λ {‖ S ‖}_{1} + {Y}^{T} ( R - L - S ) + \frac{β}{2} {‖ R - L - S ‖}_{F}$$

in which J(L,S,Y,β) represents a target function, Y represents a Lagrangian multiplier matrix, T represents a matrix transposition operation, λ represents a regularization parameter, β represents a fidelity penalty factor, ∥⋅∥_{*} represents a nuclear norm, i.e. a sum of singular values in a matrix, ∥⋅∥ₗ represents an l₁ norm, i.e. a sum of absolute values of every elements in the matrix, ∥⋅∥_{F} represents a Frobenius norm, the Frobenius norm being a square root of a sum of squares of all elements in the matrix; L represents a low-rank matrix component after decomposition of the three-dimensional angle domain imaging matrix; S represents a sparse matrix component after decomposition of the three-dimensional angle domain imaging matrix; and R represents the three-dimensional angle domain imaging matrix.

In combination with the fifth possible implementation of the first aspect, an example of the present invention provides a sixth possible implementation of the first aspect, specifically, the above step of separating a low-rank matrix component from the three-dimensional angle domain imaging matrix and determining the low-rank matrix component as the seismic diffracted wave comprises: setting the regularization parameter λ and a preset maximum iteration number N, wherein λ>0; setting an iteration number initial value k=1, an initial value L⁰ of the low-rank matrix component, an initial value S⁰ of the sparse matrix component, a Lagrangian multiplier initial value Y⁰, and a fidelity penalty factor initial value β⁰; taking k=1, the L⁰, the S⁰, the Y⁰ and the β⁰ as initial values, performing iterative processing on the three-dimensional angle domain imaging matrix, the iterative processing comprising steps as follows: performing singular value decomposition calculation through

$$( U , Σ , V ) = SVD ( R - {S}^{k - 1} + \frac{{Y}^{k - 1}}{{β}^{k - 1}} )$$

to obtain a singular value diagonal matrix, wherein R represents a three-dimensional angle domain imaging matrix, columns of U and V represent base vectors, Σ represents a diagonal matrix, and elements on opposite angles of the singular value diagonal matrix are singular values; performing a soft threshold operation on a singular value aᵢ in the singular value diagonal matrix through

$${\tilde{a}}_{i} = \{ \begin{matrix}x - {a}_{i} & if {a}_{i} > \frac{1}{β} \\ x + {a}_{i} & if {a}_{i} < - \frac{1}{β} \\ 0 & in other cases\end{matrix}$$

to obtain a new diagonal matrix \tilde{Σ}, wherein x represents a preset fixed value; calculating the low-rank matrix component L^{k} and the sparse matrix component S^{k} according to the new diagonal matrix \tilde{E}; judging whether L^{k} and S^{k} satisfy a relational expression

$$\frac{{‖ R - {L}^{k} - {S}^{k} ‖}_{F}}{{‖ R ‖}_{F}} \geq δ$$

and k≤N; and if yes, updating k=k+1, the Lagrangian multiplier Y^{k}=Y^{k-1}+β^{k-1}(R−L^{k}−S^{k}), and the fidelity penalty factor β^{k}=ωβ^{k-1} (ω>0), wherein ω represents a scale factor, and continuing to perform the iterative processing; if no, determining L^{k} as a separated seismic diffracted wave.

In combination with the sixth possible implementation of the first aspect, an example of the present invention provides a seventh possible implementation of the first aspect, specifically, the above step of calculating the low-rank matrix component L^{k} and the sparse matrix component S^{k} according to the new diagonal matrix \tilde{Σ} comprises: calculating, according to the new diagonal matrix \tilde{Σ}, the low-rank matrix component: L^{k}=U\tilde{Σ}V and calculating the sparse matrix component:

$${S}_{j}^{k} = \{ \begin{matrix}{A}_{j} ( 1 - \frac{λ}{β {‖ {A}_{j} ‖}_{2}} ) & if {‖ {A}_{j} ‖}_{2} > \frac{λ}{β} \\ 0 & if {‖ {A}_{j} ‖}_{2} < \frac{λ}{β} \end{matrix} ,$$

wherein

$${A}_{j} = {R}_{j} - {L}_{j}^{k} + \frac{{Y}_{j}^{k - 1}}{{β}^{k - 1}} ,$$

j represents a j-th column of the matrix, and ∥⋅∥₂ represents an l₂ norm.

In a second aspect, an example of the present invention provides an apparatus for separating a seismic diffracted wave, comprising: a data acquiring module, configured to acquire seismic shot gather data carrying underground geological information in a preset geological region, wherein the underground geological information comprises geological structure information and geological lithology change information; a wave field back-propagation processing module, configured to perform wave field back-propagation processing on the seismic shot gather data to obtain azimuth, emergence angle and amplitude information of propagation rays corresponding one by one to underground imaging points in the preset geological region; a matrix generating module, configured to generate a three-dimensional angle domain imaging matrix according to the azimuth, emergence angle and amplitude information of the propagation rays; and a separating module, configured to separate a low-rank matrix component from the three-dimensional angle domain imaging matrix and determine the low-rank matrix component as the seismic diffracted wave.

In combination with the second aspect, an example of the present invention provides a first possible implementation of the second aspect, specifically, the above wave field back-propagation processing module comprises: a preprocessing unit, configured to preprocess the seismic shot gather data to obtain preprocessed single-shot data, wherein the preprocessed single-shot data is seismic shot gather data usable for direct imaging, and the preprocessing comprises de-noising the seismic shot gather data and making the seismic shot gather data corresponding to pre-stored historical seismic data one by one; a wave field back-propagation processing unit, configured to input the preprocessed single-shot data and a preset migration velocity model to a three-dimensional single-shot angle domain imaging formula and perform the wave field back-propagation processing on the seismic shot gather data to obtain the azimuth, emergence angle and amplitude information of the propagation rays corresponding one by one to the underground imaging points in the preset geological region, wherein the three-dimensional single-shot angle domain imaging formula includes a three-dimensional amplitude compensation factor.

The examples of the present invention bring about the following beneficial effects:

in the method and the apparatus for separating a seismic diffracted wave provided in the examples of the present invention, by performing the wave field back-propagation processing on the seismic shot gather data carrying the underground geological information in the preset geological region, the azimuth, emergence angle and amplitude information of the propagation rays corresponding one by one to the underground imaging points in the preset geological region can be obtained; according to the azimuth, emergence angle and amplitude information of the propagation rays, the three-dimensional angle domain imaging matrix can be generated, and the low-rank matrix component can be separated from the three-dimensional angle domain imaging matrix, further the low-rank matrix component is determined as the seismic diffracted wave; the above mode of obtaining the seismic diffracted wave by constructing the three-dimensional angle domain imaging matrix and separating the low-rank matrix component can improve the amplitude integrity and the waveform consistency of the separated diffracted wave, and further improve resolution of imaging of the geological structures.

Other features and advantages of the present invention will be illustrated in the following description, and partially become apparent in the description, or will be understood by implementing the present invention. The objects and other advantages of the present invention are realized by and obtained from structures specially indicated in the description, the claims and the figures.

In order to make the above objects, features and advantages of the present invention more obvious and easier to understand, preferable examples are particularly illustrated in the following to make detailed description in conjunction with the accompanying drawings.

### BRIEF DESCRIPTION OF DRAWINGS

In order to more clearly illustrate technical solutions of embodiments of the present invention or the prior art, figures which are needed for description of the embodiments or the prior art will be introduced briefly below. Obviously, the figures in the description below show some embodiments of the present invention. A person ordinarily skilled in the art still can obtain other figures according to these figures, without using inventive efforts.

FIG. 1 is a flow chart of a method for separating a seismic diffracted wave provided in an example of the present invention;

FIG. 2 is a specific flow chart of separating a low-rank matrix component from a three-dimensional angle domain imaging matrix and determining the low-rank matrix component as a seismic diffracted wave in a method for separating a seismic diffracted wave provided in an example of the present invention;

FIG. 3 is a structural schematic diagram of an apparatus for separating a seismic diffracted wave provided in an example of the present invention; and

FIG. 4 is a specific structural schematic diagram of a separating module in an apparatus for separating a seismic diffracted wave provided in an example of the present invention.

### DETAILED DESCRIPTION OF EMBODIMENTS

In order to make the objects, the technical solutions and the advantages of the examples of the present invention clearer, below the technical solutions of the present invention will be described clearly and completely in conjunction with figures. Apparently, some but not all of examples of the present invention are described. Based on the examples of the present invention, all the other examples, which a person ordinarily skilled in the art obtains without using inventive efforts, fall within the scope of protection of the present invention.

Considering the problem that amplitude integrity and waveform consistency of the diffracted wave separated by the existing manner of separating the seismic diffracted wave are relatively poor, examples of the present invention provide a method and an apparatus for separating a seismic diffracted wave, which technology can be applied to analysis of complex geological structures and lithology according to properties of the diffracted wave, and also can be applied to exploration of oil-gas reservoir performed according to the diffracted wave; and this technology can be implemented using relevant software and hardware, and is described through the examples below.

### Example 1

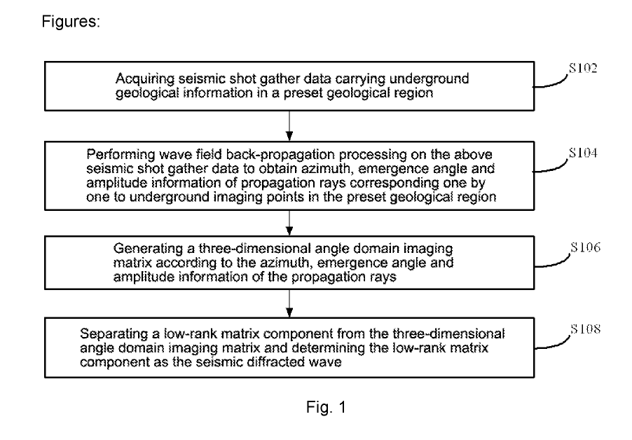

Referring to a flow chart of a method for separating a seismic diffracted wave shown in FIG. 1, the method comprises the following steps:

Step S102, acquiring seismic shot gather data carrying underground geological information in a preset geological region, wherein the underground geological information comprises geological structure information and geological lithology change information; specifically, the underground geological information may be information such as stratum structure, fault, karst cave and lithology sudden-change point;

Step S104, performing wave field back-propagation processing on the above seismic shot gather data to obtain azimuth, emergence angle and amplitude information of propagation rays corresponding one by one to underground imaging points in the preset geological region;

Step S106, generating a three-dimensional angle domain imaging matrix according to the azimuth, emergence angle and amplitude information of the propagation rays, wherein specifically, the three-dimensional angle domain imaging matrix is associated with the above azimuth and emergence angle, and the three-dimensional angle domain imaging matrix may be used to separate the diffracted wave;

Step S108, separating a low-rank matrix component from the three-dimensional angle domain imaging matrix and determining the low-rank matrix component as the seismic diffracted wave, wherein in practical implementation, the low-rank matrix component and a sparse matrix component may be separated from the three-dimensional angle domain imaging matrix, wherein the sparse matrix component may be determined as the seismic reflected wave.

In the method for separating a seismic diffracted wave provided in the example of the present invention, by performing the wave field back-propagation processing on the seismic shot gather data carrying the underground geological information in the preset geological region, the azimuth, emergence angle and amplitude information of the propagation rays corresponding one by one to the underground imaging points in the preset geological region can be obtained; according to the azimuth, emergence angle and amplitude information of the propagation rays, the three-dimensional angle domain imaging matrix can be generated, and the low-rank matrix component can be separated from the three-dimensional angle domain imaging matrix, further the low-rank matrix component is determined as the seismic diffracted wave; the above mode of obtaining the seismic diffracted wave by constructing the three-dimensional angle domain imaging matrix and separating the low-rank matrix component can improve the amplitude integrity and the waveform consistency of the separated diffracted wave, and further improve resolution of imaging of the geological structures.

Considering the relatively poor processability of the acquired seismic shot gather data, the above step of performing wave field back-propagation processing on the seismic shot gather data to obtain azimuth, emergence angle and amplitude information of propagation rays corresponding one by one to underground imaging points in the preset geological region comprises the following steps:

(1) preprocessing the seismic shot gather data to obtain preprocessed single-shot data, wherein the preprocessed single-shot data is seismic shot gather data usable for direct imaging, the above preprocessing comprises de-noising the seismic shot gather data and making the seismic shot gather data corresponding to pre-stored historical seismic data one by one; and further, the above preprocessing also may comprise uploading an observing system; and

(2) inputting the above preprocessed single-shot data and a preset migration velocity model to a three-dimensional single-shot angle domain imaging formula, and performing the wave field back-propagation processing on the seismic shot gather data, to obtain the azimuth, emergence angle and amplitude information of the propagation rays corresponding one by one to the underground imaging points in the preset geological region, wherein the three-dimensional single-shot angle domain imaging formula includes a three-dimensional amplitude compensation factor.

Specifically, the above step (2) also may be completed in the following manner: according to the above preprocessed single-shot data and the input migration velocity model, completing the wave field back-propagation of the preprocessed single-shot data through the three-dimensional single-shot angle domain imaging formula to obtain the azimuth, emergence angle and amplitude information of the propagation rays corresponding to any underground imaging point position.

The above method improves the subsequent processability of data by preprocessing the acquired seismic shot gather data.

Further, the above three-dimensional single-shot angle domain imaging formula can be expressed as:

$$R ( x , {θ}_{0} , {ϕ}_{0} ) = \int \int δ ( θ - {θ}_{0} ) δ ( ϕ - {ϕ}_{0} ) δ ( t - {t}_{0} ) {W}_{3 D} ( s , x , r ) u ( s , r , t ) drdt$$

$$\{ \begin{matrix}cos {θ}_{0} = \frac{k \cdot {k}_{r}}{\vert k \vert \vert {k}_{r} \vert} \\ cos {ϕ}_{0} = \frac{( {k}_{s} \times {k}_{r} ) \cdot ( {n}_{x} \times ( {k}_{s} + {k}_{r} ) )}{\vert {k}_{s} \times {k}_{r} \vert \vert {n}_{x} \times ( {k}_{s} + {k}_{r} ) \vert}\end{matrix}$$

in which δ represents an impulse function, R(x,θ₀,φ₀) represents a three-dimensional angle domain imaging matrix, wherein a ray excited by a hypocenter s reaches a demodulation point position r through any imaging point x in an underground space; a vector kₛ represents a ray parameter from the hypocenter to the imaging point, a vector kᵣ represents a ray parameter from the demodulation point to the imaging point; a parameter θ represents an emergence angle; a parameter φ represents an azimuth; a vector k represents a normal vector of an assumed reflecting interface; k is calculated through the following formula k(θₘ,φₘ)=kₛ(θₛ,φₛ)+kᵣ(θᵣ,φᵣ), θₛ and φₛ represent an emergence angle and an azimuth of k, respectively; θᵣ and φᵣ represent an emergence angle and an azimuth of kᵣ respectively; θₘ and φₘ represent an emergence angle and an azimuth of the assumed reflecting interface respectively; nₓ represents a normal vector in an x direction of a three-dimensional coordinate system, and nₓ=(1,0,0); u(s,r,t) represents seismic data, t represents recording time of the seismic data; t₀ represents ray travel time; and W_{3D}(s,x,r) represents a three-dimensional amplitude compensation factor.

The above three-dimensional amplitude compensation factor W_{3D}(s,x,r) can be specifically expressed as:

$${W}_{3 D} ( s , x , r ) = \frac{1}{{v}_{s}} \sqrt{cos {α}_{s} cos {α}_{r}} \frac{\vert det ( {\underline{N}}_{1}^{T} \underline{Σ} + {\underline{N}}_{2}^{T} \underline{Γ} ) \vert}{\sqrt{\vert det {\underline{N}}_{1} \vert \vert det {\underline{N}}_{2} \vert}} {e}^{- i \frac{π}{2} ( {κ}_{1} + {κ}_{2} )}$$

in which νₛ represents a velocity at a hypocenter position, αₛ represents an incident angle of a ray at the hypocenter position, αᵣ represents an emergence angle of a ray at the demodulation point position, N₁ and N₂ represent mixed derivatives of the travel time of a first ray and a second ray with respect to the hypocenter position and the demodulation point position respectively, T represents a matrix transposition operation, wherein the travel time is calculated according to three-dimensional wavefront reconstruction method ray tracing, and multi-valued travel time is taken into consideration in the calculation; the first ray is a ray from the hypocenter to the imaging point; the second ray is a ray from the demodulation point to the imaging point; Σ and Γ represent matrixes related to a manner of seismic observation, and in a situation of common shot observation, Σ=0, Γ=I, wherein I represents a unit matrix; i represents an imaginary unit of a complex number, and κ₁ and κ₂ represent numbers of caustic points of the first ray and the second ray respectively, with κ₁ and κ₂ being calculated by a three-dimensional ray tracing kinetics equation.

In order to accurately and highly-effectively separate the seismic diffracted wave, the above step of separating the low-rank matrix component from the three-dimensional angle domain imaging matrix and determining the low-rank matrix component as the seismic diffracted wave can be realized in the following manner: separating, through a preset three-dimensional diffracted wave separating model, the low-rank matrix component from the three-dimensional angle domain imaging matrix, and determining the low-rank matrix component as the seismic diffracted wave, wherein the preset three-dimensional diffracted wave separating model comprises:

R(xᵢ,θ,φ)=L(xᵢ,θ,φ)+S(xᵢ,θ,φ)

in which R(x,θ,φ) represents a three-dimensional angle domain imaging matrix of an i-th imaging point at a position xᵢ; L(xᵢ,θ,φ) represents a low-rank matrix component after decomposition of the three-dimensional angle domain imaging matrix; S(xᵢ,θ,φ) represents a sparse matrix component after decomposition of the three-dimensional angle domain imaging matrix; xᵢ represents the i-th imaging point; a parameter θ represents an emergence angle; and a parameter φ represents an azimuth.

In the above three-dimensional angle domain imaging matrix, a numerical value of each element is an amplitude value, including reflected wave and diffracted wave information; according to Snell's theorem, incident rays and emergence rays of the reflected waves are located in the same plane, and the emergence angle is equal to the incident angle; the reflected waves are distributed at positions of specific azimuth and emergence angle in the three-dimensional angle domain imaging matrix, and has sparsity; according to Huygens' Principle, the diffracted waves are propagated in a form of spherical waves, and therefore, are distributed at positions of individual azimuths and emergence angles in the angle domain imaging matrix, and have low-rank property, wherein the above sparsity means that most of elements in the matrix are zero and can be used to represent the characteristic of the reflected waves in the three-dimensional angle domain imaging matrix; the above low-rank property means that the elements in the matrix are distributed repeatedly or approximately uniformly, and can be used to represent the characteristics of the diffracted wave in the three-dimensional angle domain imaging matrix.

Preferably, according to the definition of augmented Lagrangian function, the above preset three-dimensional diffracted wave separating model may also be expressed as:

$$J ( L , S , Y , β ) = {‖ L ‖}_{*} + λ {‖ S ‖}_{1} + {Y}^{T} ( R - L - S ) + \frac{β}{2} {‖ R - L - S ‖}_{F}$$

in which J(L,S,Y,β) represents a target function, Y represents a Lagrangian multiplier matrix, T represents a matrix transposition operation, λ represents a regularization parameter, β represents a fidelity penalty factor, ∥⋅∥_{*} represents a nuclear norm, i.e. a sum of singular values in a matrix, ∥⋅∥ₗ represents an l₁ norm, i.e. a sum of absolute values of every elements in the matrix, ∥⋅∥_{F} represents a Frobenius norm, the Frobenius norm being a square root of a sum of squares of all elements in the matrix; L represents a low-rank matrix component after decomposition of the three-dimensional angle domain imaging matrix; S represents a sparse matrix component after decomposition of the three-dimensional angle domain imaging matrix; and R represents the three-dimensional angle domain imaging matrix.

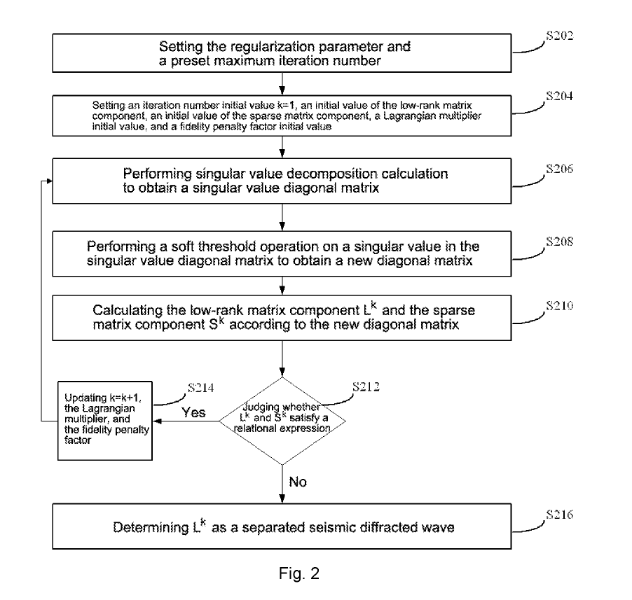

Referring to a specific flow chart of separating the low-rank matrix component from the three-dimensional angle domain imaging matrix and determining the low-rank matrix component as the seismic diffracted wave in the method for separating a seismic diffracted wave as shown in FIG. 2, the method can be implemented through the above three-dimensional diffracted wave separating model; the method comprises the following steps:

Step S202, setting the regularization parameter λ and a preset maximum iteration number N, wherein λ>0, and in practical implementation, a numerical value of λ may be determined according to experience, and a value range of λ is 0<λ<1;

Step S204, setting an iteration number initial value k=1, an initial value L⁰ of the low-rank matrix component, an initial value S⁰ of the sparse matrix component, a Lagrangian multiplier initial value Y⁰, and a fidelity penalty factor initial value β⁰.

Step S206, performing singular value decomposition calculation through

$$( U , Σ , V ) = SVD ( R - {S}^{k - 1} + \frac{{Y}^{k - 1}}{{β}^{k - 1}} )$$

to obtain a singular value diagonal matrix, wherein R represents a three-dimensional angle domain imaging matrix, columns of U and V represent base vectors, Σ represents a diagonal matrix, and elements on opposite angles of the singular value diagonal matrix are singular values;

Step S208, performing a soft threshold operation on a singular value aᵢ in the singular value diagonal matrix through

$${\tilde{a}}_{i} = \{ \begin{matrix}x - {a}_{i} & if {a}_{i} > \frac{1}{β} \\ x + {a}_{i} & if {a}_{i} < - \frac{1}{β} \\ 0 & in other cases\end{matrix}$$

to obtain a new diagonal matrix, \tilde{Σ}, wherein x represents a preset fixed value;

Step S210, calculating the low-rank matrix component L^{k} and the sparse matrix component S^{k} according to the new diagonal matrix \tilde{Σ};

Step S212, judging whether L^{k} and S^{k} satisfy a relational expression

$$\frac{{‖ R - {L}^{k} - {S}^{k} ‖}_{F}}{{‖ R ‖}_{F}} \geq δ$$

and k≤N, and if yes, performing Step S214, if no, performing Step S216;

Step S214, updating k=k+1, the Lagrangian multiplier Y^{k}=Y^{k-1}+β^{k-1}(R−L^{k}−S^{k}), and the fidelity penalty factor β^{k}=ωβ^{k-1} (ω>0), wherein ω represents a scale factor; performing Step S208; and

Step S216, determining the L^{k} as a separated seismic diffracted wave.

The seismic diffracted wave with both good amplitude integrity and waveform consistency can be highly-effectively obtained through the iterative method in the above mode.

Further, the above step of calculating the low-rank matrix component L^{k} and the sparse matrix component S^{k} according to the new diagonal matrix \tilde{Σ} comprises: calculating, according to the new diagonal matrix \tilde{Σ}, the low-rank matrix component: L^{k}=U\tilde{Σ}V calculating the sparse matrix component:

$${S}_{j}^{k} = \{ \begin{matrix}{A}_{j} ( 1 - \frac{λ}{β {‖ {A}_{j} ‖}_{2}} ) & if {‖ {A}_{j} ‖}_{2} > \frac{λ}{β} \\ 0 & if {‖ {A}_{j} ‖}_{2} < \frac{λ}{β}\end{matrix} , wherein \\ {A}_{j} = {R}_{j} - {L}_{j}^{k} + \frac{{Y}_{j}^{k - 1}}{{β}^{k - 1}} ,$$

represents a j-th column of the matrix, ∥⋅∥₂ represents an l₂ norm.

### Example 2

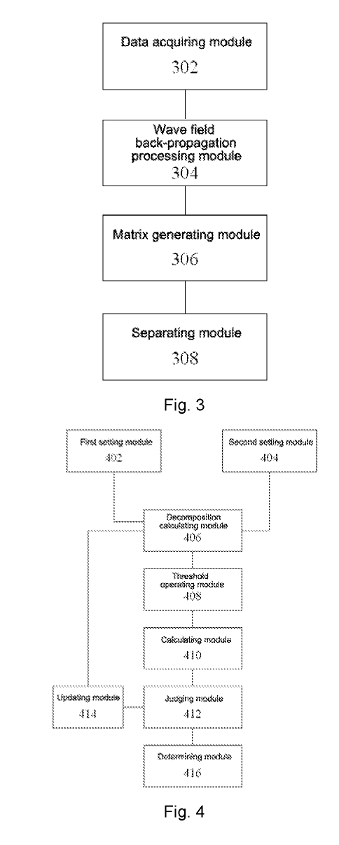

Corresponding to the above method example, referring to a structural schematic diagram of an apparatus for separating a seismic diffracted wave shown in FIG. 3, the apparatus comprises the following parts:

a data acquiring module 302, configured to acquire seismic shot gather data carrying underground geological information in a preset geological region, wherein the underground geological information comprises geological structure information and geological lithology change information;

a wave field back-propagation processing module 304, configured to perform wave field back-propagation processing on the seismic shot gather data to obtain azimuth, emergence angle and amplitude information of propagation rays corresponding one by one to underground imaging points in the preset geological region;

a matrix generating module 306, configured to generate a three-dimensional angle domain imaging matrix according to the azimuth, emergence angle and amplitude information of the propagation rays; and

a separating module 308, configured to separate a low-rank matrix component from the three-dimensional angle domain imaging matrix and determine the low-rank matrix component as the seismic diffracted wave.

In the apparatus for separating a seismic diffracted wave provided in the example of the present invention, by performing the wave field back-propagation processing on the seismic shot gather data carrying the underground geological information in the preset geological region, the azimuth, emergence angle and amplitude information of the propagation rays corresponding one by one to the underground imaging points in the preset geological region can be obtained; according to the azimuth, emergence angle and amplitude information of the propagation rays, the three-dimensional angle domain imaging matrix can be generated, and the low-rank matrix component can be separated from the three-dimensional angle domain imaging matrix, further the low-rank matrix component is determined as the seismic diffracted wave; the above mode of obtaining the seismic diffracted wave by constructing the three-dimensional angle domain imaging matrix and separating the low-rank matrix component can improve the amplitude integrity and waveform consistency of the separated diffracted wave, and further improve resolution of imaging of the geological structures.

Considering the relatively poor processability of the acquired seismic shot gather data, the above wave field back-propagation processing module comprises: (1) a preprocessing unit, configured to preprocess the seismic shot gather data to obtain preprocessed single-shot data, wherein the preprocessed single-shot data is seismic shot gather data usable for direct imaging, and the above preprocessing comprises de-noising the seismic shot gather data and making the seismic shot gather data corresponding to pre-stored historical seismic data one by one; (2) a wave field back-propagation processing unit, configured to input the preprocessed single-shot data and a preset migration velocity model to a three-dimensional single-shot angle domain imaging formula and perform the wave field back-propagation processing on the seismic shot gather data to obtain the azimuth, emergence angle and amplitude information of propagation rays corresponding one by one to the underground imaging points in the preset geological region, wherein the above three-dimensional single-shot angle domain imaging formula includes a three-dimensional amplitude compensation factor. The above method improves the subsequent processability of data by preprocessing the acquired seismic shot gather data.

In order to accurately and highly-effectively separate the seismic diffracted wave, the above separating module is further used to separate the low-rank matrix component from the three-dimensional angle domain imaging matrix and determine the low-rank matrix component as the seismic diffracted wave through a preset three-dimensional diffracted wave separating model, wherein the preset three-dimensional diffracted wave separating model comprises:

R(xᵢ,θ,φ)=L(xᵢ,θ,φ)+S(xᵢ,θ,φ)

in which R(xᵢ,θ,φ) represents a three-dimensional angle domain imaging matrix of an i-th imaging point at a position xᵢ; L(xᵢ,θ,φ) represents a low-rank matrix component after decomposition of the three-dimensional angle domain imaging matrix; S(xᵢ,θ,φ) represents a sparse matrix component after decomposition of the three-dimensional angle domain imaging matrix; xᵢ represents the i-th imaging point; a parameter θ represents an emergence angle; and a parameter φ represents an azimuth.

Referring to a specific structural schematic diagram of a separating module in an apparatus for separating a seismic diffracted wave shown in FIG. 4, the apparatus comprises the following parts:

a first setting module 402, configured to set a regularization parameter λ and a preset maximum iteration number N, wherein λ>0;

a second setting module 404, configured to set an iteration number initial value k=1, an initial value L⁰ of the low-rank matrix component, an initial value S⁰ of the sparse matrix component, a Lagrangian multiplier initial value Y⁰, and a fidelity penalty factor initial value β⁰;

a decomposition calculating module 406, configured to perform singular value decomposition calculation through

$$( U , Σ , V ) = SVD ( R - {S}^{k - 1} + \frac{{Y}^{k - 1}}{{β}^{k - 1}} )$$

to obtain a singular value diagonal matrix, wherein R represents a three-dimensional angle domain imaging matrix, columns of U and V represent base vectors, Σ represents a diagonal matrix, and elements on opposite angles of the singular value diagonal matrix are singular values;

a threshold operating module 408, configured to perform a soft threshold operation on a singular value aᵢ in the singular value diagonal matrix through

$${\tilde{a}}_{i} = \{ \begin{matrix}x - {a}_{i} & if {a}_{i} > \frac{1}{β} \\ x + {a}_{i} & if {a}_{i} < - \frac{1}{β} \\ 0 & in other cases\end{matrix}$$

to obtain a new diagonal matrix \tilde{Σ}, wherein x represents a preset fixed value;

a calculating module 410, configured to calculate the low-rank matrix component L^{k} and the sparse matrix component S^{k} according to the new diagonal matrix \tilde{Σ};

a judging module 412, configured to judge whether L^{k} and S^{k} satisfy a relational expression

$$\frac{{‖ R - {L}^{k} - {S}^{k} ‖}_{F}}{{‖ R ‖}_{F}} \geq δ$$

and k≤N;

an updating module 414, configured to update k=k+1, the Lagrangian multiplier Y^{k}=Y^{k-1}+β^{k-1} (R−L^{k}−S^{k}), and the fidelity penalty factor β^{k}=ωβ^{k-1} (ω>0) if L^{k} and S^{k} satisfy the relational expression

$$\frac{{‖ R - {L}^{k} - {S}^{k} ‖}_{F}}{{‖ R ‖}_{F}} \geq δ$$

and k≤N, wherein ω represents a scale factor; and to continue to perform iterative processing;

a determining module 416, configured to determine L^{k} as the separated seismic diffracted wave if L^{k} and S^{k} do not satisfy the relational expression

$$\frac{{‖ R - {L}^{k} - {S}^{k} ‖}_{F}}{{‖ R ‖}_{F}} \geq δ$$

and k≤N.

The seismic diffracted wave with both good amplitude integrity and waveform consistency can be highly-effectively obtained through the iterative method in the above mode.

Further, the above calculating module 410 comprises:

a first calculating unit, configured to calculate the low-rank matrix component: L^{k}=U\tilde{Σ}V according to the new diagonal matrix \tilde{Σ};

a second calculating unit, configured to calculate the sparse matrix component:

$${S}_{j}^{k} = \{ \begin{matrix}{A}_{j} ( 1 - \frac{λ}{β {‖ {A}_{j} ‖}_{2}} ) & if {‖ {A}_{j} ‖}_{2} > \frac{λ}{β} \\ 0 & if {‖ {A}_{j} ‖}_{2} < \frac{λ}{β}\end{matrix} , wherein \\ {A}_{j} = {R}_{j} - {L}_{j}^{k} + \frac{{Y}_{j}^{k - 1}}{{β}^{k - 1}} ,$$

j represents a j-th column of the matrix, and ∥⋅∥₂ represents an l₂ norm.

In contrast, among researches about separating the diffracted wave in the prior art, Harlan, et. al. (1984) removed the reflected wave using Radon transformation and separated the diffracted wave according to the principle of statistics. Bansal and Imhof (2005) studied standard modules in a seism processing flow through a signal processing method and analyzed different methods of removing the reflected wave. Taner, et. al. (2006) separated the diffracted wave by suppressing the reflected wave using a method of plane wave decomposition. By studying geometry differences of dip-angle domain diffracted wave and reflected wave, Landa and Fomel (2008) proposed a method for separating a dip-angle domain diffracted wave based on plane wave filtration. Khaidukov, et. al. (2004) proposed a focusing-removing-defocusing method to realize prestack time domain diffracted wave imaging, while this method highly relied on a velocity model, was difficult to remove the reflected wave, and had limitation in the practical application. Figueiredo, et. al. (2013) studied a method of automatic imaging of a diffracted wave using a pattern recognition technology.

In most of the above conventional methods for separating a diffracted wave, the diffracted wave is separated through a signal processing method using the kinematic characteristics of the reflected wave and the diffracted wave, and none of them studied the three-dimensional shot gather data. In the three-dimensional shot gather data, the diffracted wave has similar kinematic characteristics to the reflected wave, and is hard to be effectively processed merely through a wave-field separating method in the conventional kinematics, however, the diffracted waves in the shot gather data are excited by the same hypocenter and have strong waveform consistency, facilitating high-resolution diffracted wave imaging. Therefore, in the present invention, by studying Snell's theorem and Huygens' Principle, the three-dimensional angle domain imaging matrix is constructed for separating the three-dimensional shot gather diffracted wave, and this technology separates the diffracted wave by capturing the kinematic characteristics of the seismic data using the low-rank and sparse optimization decomposition methods, can ensure separation integrity and consistency of waveform characteristics of the diffracted wave, facilitates the high-resolution imaging, and has important application value in exploration and development of the fractured-vuggy carbonate oil-gas reservoir.

A computer program product of a method and an apparatus for separating a seismic diffracted wave provided in the examples of the present invention comprises a computer readable storage medium having stored program codes, and commands included in the program codes can be used to execute the method in the aforementioned method example. Reference can be made to the method example for specific implementation, and unnecessary details will not be given herein.

The person skilled in the art can clearly know that for making description convenient and concise, the specific working processes of the apparatus described above can refer to corresponding processes in the aforementioned method example, and unnecessary details will not be given herein.

If the function is realized in a form of software functional unit and is sold or used as an individual product, it may be stored in one computer readable storage medium. Based on such understanding, the technical solution of the present invention essentially or the part making contribution to the prior art or part of this technical solution can be embodied in a form of software product, and this computer software product is stored in one storage medium, including several commands used to make one computer device (which may be a personal computer, a sever, or a network device etc.) execute all or part of the steps of the methods of individual examples of the present invention. The aforementioned storage medium includes various media that can store program codes, such as U disk, mobile hard disk, Read-Only Memory (ROM), Random Access Memory (RAM), diskette or compact disk and so on.

Finally, it is to be explained that the above examples are merely specific embodiments of the present invention, for illustrating the technical solutions of the present invention, rather than limiting the present invention, and the protection scope of the present invention is not limited thereto. While detailed description is made to the present invention with reference to the aforementioned examples, those ordinarily skilled in the art should understand that they still can modify the technical solutions described in the aforementioned examples or easily conceive changes, or make equivalent substitutions to some technical features thereof; and with these modifications, changes or substitutions, the essence of the corresponding technical solutions does not depart from the spirit and scope of the technical solutions of the examples of the present invention, and should be covered within the protection scope of the present invention. Therefore, the protection scope of the present invention should be based on the protection scope of the claims.

1. A method for separating a seismic diffracted wave, comprising steps of:
acquiring seismic shot gather data carrying underground geological information in a preset geological region, wherein the underground geological information comprises geological structure information and geological lithology change information;
performing wave field back-propagation processing on the seismic shot gather data to obtain azimuth, emergence angle and amplitude information of propagation rays corresponding one by one to underground imaging points in the preset geological region;
generating a three-dimensional angle domain imaging matrix according to the azimuth, emergence angle and amplitude information of the propagation rays; and
separating a low-rank matrix component from the three-dimensional angle domain imaging matrix and determining the low-rank matrix component as the seismic diffracted wave.

2. The method according to claim 1, wherein the step of performing wave field back-propagation processing on the seismic shot gather data to obtain azimuth, emergence angle and amplitude information of propagation rays corresponding one by one to underground imaging points in the preset geological region comprises:
preprocessing the seismic shot gather data to obtain preprocessed single-shot data, wherein the preprocessed single-shot data is seismic shot gather data usable for direct imaging, and the preprocessing comprises de-noising the seismic shot gather data and making the seismic shot gather data corresponding to pre-stored historical seismic data one by one; and
inputting the preprocessed single-shot data and a preset migration velocity model to a three-dimensional single-shot angle domain imaging formula, and performing the wave field back-propagation processing on the seismic shot gather data to obtain the azimuth, emergence angle and amplitude information of the propagation rays corresponding one by one to the underground imaging points in the preset geological region, wherein the three-dimensional single-shot angle domain imaging formula includes a three-dimensional amplitude compensation factor.

3. The method according to claim 2, wherein the three-dimensional single-shot angle domain imaging formula comprises:
$$R ( x , {θ}_{0} , {ϕ}_{0} ) = \int \int δ ( θ - {θ}_{0} ) δ ( ϕ - {ϕ}_{0} ) δ ( t - {t}_{0} ) {W}_{3 D} ( s , x , r ) u ( s , r , t ) drdt$$
$$\{ \begin{matrix}cos {θ}_{0} = \frac{k \cdot {k}_{r}}{\vert k \vert \vert {k}_{r} \vert} \\ cos {ϕ}_{0} = \frac{( {k}_{S} \times {k}_{r} ) \cdot ( {n}_{x} \times ( {k}_{S} + {k}_{r} ) )}{\vert {k}_{S} \times {k}_{r} \vert \vert {n}_{x} \times ( {k}_{S} + {k}_{r} ) \vert}\end{matrix}$$
in which δ represents an impulse function, R(x,θ₀,φ₀) represents a three-dimensional angle domain imaging matrix, wherein a ray excited by a hypocenter s reaches a demodulation point position r through any imaging point x in an underground space; a vector kₛ represents a ray parameter from the hypocenter to the imaging point, a vector kᵣ represents a ray parameter from the demodulation point to the imaging point; a parameter θ is an emergence angle; a parameter φ represents an azimuth; a vector k represents a normal vector of an assumed reflecting interface; k is calculated through a following formula k(θₘ,φₘ)=kₛ(θₛ,φₛ)+kᵣ(θᵣ,φᵣ); θₛ and φₛ represent an emergence angle and an azimuth of kₛ respectively; θᵣ and φᵣ represent an emergence angle and an azimuth of kᵣ respectively; θₘ and φₘ represent an emergence angle and an azimuth of the assumed reflecting interface respectively; nₓ represents a normal vector in an x direction of a three-dimensional coordinate system, and nₓ=(1,0,0); u(s,r,t) represents seismic data, t represents recording time of the seismic data; t₀ represents ray travel time; and W_{3D}(s,x,r) represents a three-dimensional amplitude compensation factor.

4. The method according to claim 3, wherein the three-dimensional amplitude compensation factor W_{3D}(s,x,r) comprises:
$${W}_{3 D} ( s , x , r ) = \frac{1}{{v}_{s}} \sqrt{cos {α}_{s} cos {α}_{r}} \frac{\vert det ( {\underline{N}}_{1}^{T} \underline{Σ} + {\underline{N}}_{2}^{T} \underline{Γ} ) \vert}{\sqrt{\vert det {\underline{N}}_{1} \vert \vert det {\underline{N}}_{2} \vert}} {e}^{- i \frac{π}{2} ( {κ}_{1} + {κ}_{2} )}$$
in which νₛ represents a velocity at a hypocenter position, αₛ represents an incident angle of a ray at the hypocenter position, αᵣ represents an emergence angle of a ray at the demodulation point position ray, N₁ and N₂ represent mixed derivatives of the travel time of a first ray and a second ray with respect to the hypocenter position and the demodulation point position respectively, T represents a matrix transposition operation, wherein the travel time is calculated according to three-dimensional wavefront reconstruction method ray tracing, and multi-valued travel time is taken into consideration in the calculation; the first ray is a ray from the hypocenter to the imaging point; the second ray is a ray from the demodulation point to the imaging point; Σ and Γ represent matrixes related to a manner of seismic observation, and in a situation of common shot observation, Σ=0, Γ=I, wherein I represents a unit matrix; i represents an imaginary unit of a complex number, and κ₁ and κ₂ represent numbers of caustic points of the first ray and the second ray, with κ₁ and κ₂ being calculated by a three-dimensional ray tracing kinetics equation.

5. The method according to claim 1, wherein the step of separating a low-rank matrix component from the three-dimensional angle domain imaging matrix and determining the low-rank matrix component as the seismic diffracted wave comprises: separating, through a preset three-dimensional diffracted wave separating model, the low-rank matrix component from the three-dimensional angle domain imaging matrix, and determining the low-rank matrix component as the seismic diffracted wave, wherein the preset three-dimensional diffracted wave separating model comprises:
R(xᵢ,θ,φ)=L(xᵢ,θ,φ)+S(xᵢ,θ,φ)
in which R(xᵢ,θ,φ) represents a three-dimensional angle domain imaging matrix of an i-th imaging point at a position xᵢ; L(xᵢ,θ,φ) represents a low-rank matrix component after decomposition of the three-dimensional angle domain imaging matrix; S(xᵢ,θ,φ) represents a sparse matrix component after decomposition of the three-dimensional angle domain imaging matrix; represents the i-th imaging point; a parameter θ represents an emergence angle; and a parameter φ represents an azimuth.

6. The method according to claim 5, wherein the preset three-dimensional diffracted wave separating model further comprises:
$$J ( L , S , Y , β ) = {‖ L ‖}_{*} + λ {‖ S ‖}_{1} + {Y}^{T} ( R - L - S ) + \frac{β}{2} {‖ R - L - S ‖}_{F}$$
in which J(L,S,Y,β) represents a target function, Y represents a Lagrangian multiplier matrix, T represents a matrix transposition operation, λ represents a regularization parameter, β represents a fidelity penalty factor, ∥⋅∥_{*} represents a nuclear norm, i.e. a sum of singular values in a matrix, ∥⋅∥ₗ represents an l₁ norm, i.e. a sum of absolute values of every elements in the matrix, ∥⋅∥_{F} represents a Frobenius norm, the Frobenius norm being a square root of a sum of squares of all elements in the matrix; L represents a low-rank matrix component after decomposition of the three-dimensional angle domain imaging matrix; S represents a sparse matrix component after decomposition of the three-dimensional angle domain imaging matrix; and R represents the three-dimensional angle domain imaging matrix.

7. The method according to claim 6, wherein the step of separating a low-rank matrix component from the three-dimensional angle domain imaging matrix and determining the low-rank matrix component as the seismic diffracted wave comprises:
setting the regularization parameter λ and a preset maximum iteration number N, wherein λ>0;
setting an iteration number initial value k=1, an initial value L⁰ of the low-rank matrix component, an initial value S⁰ of the sparse matrix component, a Lagrangian multiplier initial value Y⁰, and a fidelity penalty factor initial value β⁰;
taking k=1, the L⁰, the S⁰, the Y⁰ and the β⁰ as initial values, performing iterative processing on the three-dimensional angle domain imaging matrix, the iterative processing comprising steps of:
performing singular value decomposition calculation through
$$( U , Σ , V ) = SVD ( R - {S}^{k - 1} + \frac{{Y}^{k - 1}}{{β}^{k - 1}} )$$
to obtain a singular value diagonal matrix, wherein R represents a three-dimensional angle domain imaging matrix; columns of U and V represent base vectors; Σ represents a diagonal matrix; and elements on opposite angles of the singular value diagonal matrix are singular values;
performing a soft threshold operation on a singular value aᵢ in the singular value diagonal matrix through
$${\tilde{a}}_{i} = \{ \begin{matrix}x - {a}_{i} & if {a}_{i} > \frac{1}{β} \\ x + {a}_{i} & if {a}_{i} < - \frac{1}{β} \\ 0 & in other cases\end{matrix}$$
to obtain a new diagonal matrix \tilde{Σ}, wherein x represents a preset fixed value;
calculating the low-rank matrix component L^{k} and the sparse matrix component S^{k} according to the new diagonal matrix \tilde{Σ};
judging whether the L^{k} and S^{k} satisfy a relational expression
$$\frac{{‖ R - {L}^{k} - {S}^{k} ‖}_{F}}{{‖ R ‖}_{F}} \geq δ$$
and k≤N; and
if yes, updating k=k+1, the Lagrangian multiplier Y^{k}=Y^{k-1}(R−L^{k}−S^{k}), and the fidelity penalty factor β^{k}=ωβ^{k-1}(ω>0), wherein ω represents a scale factor; and continuing to perform the iterative processing;
if no, determining the L^{k} as a separated seismic diffracted wave.

8. The method according to claim 7, wherein the steps of calculating the low-rank matrix component L^{k} and the sparse matrix component S^{k} according to the new diagonal matrix \tilde{Σ} comprises:
calculating, according to the new diagonal matrix \tilde{Σ}, the low-rank matrix component: L^{k}=U\tilde{Σ}V; and
calculating the sparse matrix component:
$${S}_{j}^{k} = \{ \begin{matrix}{A}_{j} ( 1 - \frac{λ}{β {‖ {A}_{j} ‖}_{2}} ) & if {‖ {A}_{j} ‖}_{2} > \frac{λ}{β} \\ 0 & if {‖ {A}_{j} ‖}_{2} < \frac{λ}{β}\end{matrix} , wherein \\ {A}_{j} = {R}_{j} - {L}_{j}^{k} + \frac{{Y}_{j}^{k - 1}}{{β}^{k - 1}} ,$$
represents a j-th column of the matrix, and ∥⋅∥₂ represents an l₂ norm.

9. An apparatus for separating a seismic diffracted wave, comprising:
a data acquiring module, configured to acquire seismic shot gather data carrying underground geological information in a preset geological region, wherein the underground geological information comprises geological structure information and geological lithology change information;
a wave field back-propagation processing module, configured to perform wave field back-propagation processing on the seismic shot gather data to obtain azimuth, emergence angle and amplitude information of propagation rays corresponding one by one to underground imaging points in the preset geological region;
a matrix generating module, configured to generate a three-dimensional angle domain imaging matrix according to the azimuth, emergence angle and amplitude information of the propagation rays; and
a separating module, configured to separate a low-rank matrix component from the three-dimensional angle domain imaging matrix and determine the low-rank matrix component as the seismic diffracted wave.

10. The apparatus according to claim 9, wherein the wave field back-propagation processing module comprises:
a preprocessing unit, configured to preprocess the seismic shot gather data to obtain preprocessed single-shot data, wherein the preprocessed single-shot data is seismic shot gather data usable for direct imaging, and the preprocessing comprises de-noising the seismic shot gather data and making the seismic shot gather data corresponding to pre-stored historical seismic data one by one; and
a wave field back-propagation processing unit, configured to input the preprocessed single-shot data and a preset migration velocity model to a three-dimensional single-shot angle domain imaging formula and perform the wave field back-propagation processing on the seismic shot gather data to obtain the azimuth, emergence angle and amplitude information of propagation rays corresponding one by one to the underground imaging points in the preset geological region, wherein the three-dimensional single-shot angle domain imaging formula includes a three-dimensional amplitude compensation factor.
